(19) United States
(12) Patent Application Publication
(10) Pub. No.: US 2003/0126751 A1
(43) Pub. Date: Jul. 10, 2003

(54) LEVELING ASSEMBLY FOR SETTING A VERTICAL PROP

(76) Inventor: Shuhei Izumi, Toyama-shi (JP)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/044,415

(22) Filed: Jan. 9, 2002

(51) Int. Cl. G01C 9/00

(52) U.S. Cl. 33/333

(57) ABSTRACT

A leveling assembly for setting a vertical prop comprised of inclined surface setting member 20 and horizontal surface forming member 30 wherein; the horizontal surface forming member 30 has a horizontal surface 32 to be adjusted as being horizontal and a first adjusting surface 31 formed by surface not parallel to horizontal surface 32, the inclined surface setting member 20 has a setting surface 21 facing a slope inclined surface 11 and a second adjusting surface 22 facing the first adjusting surface 31 formed by a surface not parallel to setting surface 21, and, the horizontal surface forming member 30 and inclined surface setting member 20 to be piled up to make the first adjusting surface 31 and the second adjusting surface 21 next to each other, and, the horizontal surface 32 to be horizontal to the slope inclined surface 11 by rotating relatively the position and changing degree between the horizontal surface 32 and the setting surface 21.

### BACKGROUND OF THE INVENTION

1. The Field of the Invention

The present invention relates to a leveling assembly for setting a pole such as a vertical prop set vertically to be fixed on a slope inclined surface. Slope may be indoor or outdoor.

2. Description of Related Art

A theme to build up city and house good to handicaps and elders with a keyword “barrier free” are closed up in recent years. Barrier free means to achieve structure indoor or outdoor without steps and differences in levels and able to come and go with wheelchair freely.

Under thought of barrier free, slopes are formed at places having differences in levels instead of or in addition to stairs. Further, generally handrails are provided along slopes.

The handrail set along the slope is fixed to handrail poles or props set vertically at plural points regardless of inclination degree of the slope. Dais set between the bottom of the handrail and the slope is prepared in standards of many kinds depend on inclination of the slope.

However, preparing dais which matches the inclination of each slope imposes a big burden on parts supplier.

And, in case of slope that gradually changes in inclination, preparing plural kinds of dais imposes a big burden on worker, too.

Further, inclination of slope can be calculated at designing step, but often small difference yields between slope at designing step and slope made actually. Adjusting such difference is hardly done by using the dais already prepared at work, i.e. adjusting is done by artisan technique of worker or work is done while worker shuts his eyes to difference.

In the example mentioned above, setting handrail poles on slope is explained as an example, however, setting or burying vertical prop on inclined surface causes the same problem.

Accordingly, an object of the present invention is to lighten burden on parts supplier and at the same time lighten burden on worker and not to depend on worker's skill when setting vertical prop on the slope inclined surface.

An object of the present invention mentioned in Claim 1 is to provide a leveling assembly for setting a vertical prop which lightens burden on parts supplier and at the same time lightens burden on worker and not to depend on worker's skill.

Next, an object of the present invention mentioned in Claim 2 and 3 is to supply a leveling assembly for setting a vertical prop which lightens burden on worker at adjusting work.

Further, an object of the present invention mentioned in Claim 4 is to supply a leveling assembly for setting a vertical prop which hardly causes slackness, etc. after work.

Before applying the present application, the present applicant conducted prior arts search with using the patent reference database named “Cyber Patent Desk” supplied by Nomura Sogo Kenkyujo Inc.

In keyword reference or retrieval to patent claims, a formula “(sprit level) and (prop or pole)” is referred and 36 cases are extracted. And, patent unexamined publication such as No. hei 9-280865 and No. hei 11-63995 are picked up and examined, but the present applicant recognizes that they are not the same art as the present application.

### SUMMARY OF THE INVENTION

To solve the mentioned problems, the present invention mentioned in Claim 1 provides a leveling assembly for setting a vertical prop comprised of an inclined surface setting member set on slope inclined surface and a horizontal surface forming member for fixing a vertical prop to be set vertically wherein; said horizontal surface forming member having an upper horizontal surface set horizontal and a lower first adjusting surface formed by a surface not parallel to said horizontal surface, said inclined surface setting member having a lower setting surface set on the slope inclined surface and an upper second adjusting surface formed by a surface not parallel to said setting surface, and, said horizontal surface forming member and said inclined surface setting member to be piled to make said first adjusting surface and said second adjusting surface facing to each other, and, said horizontal surface to be always horizontal to the slope inclined surface by rotating relatively said piling position and changing degree between said horizontal surface and said setting surface.

In this case, “slope inclined surface” may be indoor or outdoor. Therefore, when the slope inclined surface is set inside house a leveling assembly for setting a vertical prop of the present invention is to be “zagane or metal washer” as parts for house, and when the slope inclined surface is set outside house a leveling assembly for setting a vertical prop of the present invention is to be “dais” as parts for civil engineering.

“Vertical prop” is a member to be stood and fixed vertically to length-wise direction of the member, for example handrail pole to support handrail. Vertical prop has a structure of being vertical to its length-wise direction when fixed to the horizontal surface of the horizontal surface forming member.

The setting surface of the inclined surface setting member is set to face the slope inclined surface and then the inclined surface setting member is fixed thereto. Next, the horizontal surface forming member is placed temporarily by piling up the first adjusting surface of the horizontal surface forming member on the second adjusting surface of the inclined surface setting member. And, when the first adjusting surface is rotated relatively to the second adjusting surface, degree between horizontal surface and setting surface can be changed so the horizontal surface is adjusted to be horizontal. Moreover, the inclined surface setting member may be rotated properly and adjusted to be appropriate matching degree.

When the horizontal surface becomes horizontal, the horizontal surface forming member and the inclined surface setting member are fixed. And vertical prop is fixed to the horizontal surface.

By a leveling assembly for setting a vertical prop of the present invention, within degree changing range of the horizontal surface, supplying one kind is enough and burden of parts supplier may be lightened.

To solve the above-mentioned problems, the present invention mentioned in Claim 2 provides a leveling assembly for setting a vertical prop mentioned in Claim 1 being characterized in that; said first adjusting surface and said second adjusting surface are formed by cutting a column member in obliquity into two members at their cutting surfaces, and, graduation for grasping relative position of each other is set on peripheral surface of said inclined surface setting member and peripheral surface of said horizontal surface forming member.

By forming the graduation for grasping relative position of each other, adjusting work of degree of horizontal surface by rotating the first adjusting surface to the second adjusting surface is easily done.

To solve the mentioned problems, the present invention mentioned in Claim 3 provides a leveling assembly for setting a vertical prop mentioned in Claim 1 or 2 being characterized in that a sprit level for confirming its horizontal position is provided on the horizontal surface of the horizontal surface forming member.

The sprit level is provided so adjusting the horizontal surface to be horizontal becomes extremely easy when the second adjusting surface and the first adjusting surface are relatively rotated and degree between the horizontal surface and the setting surface is changed. Accordingly, burden of worker is lightened and keeping certain work quality without depending on worker's skill is possible.

To solve the mentioned problems, the present invention mentioned in Claim 4 provides a leveling assembly for setting a vertical prop mentioned in any one of Claims 1˜3 being characterized in that a base cover is provided around said inclined surface setting member and said horizontal surface forming member to hide them.

By covering the inclined surface setting member and the horizontal surface forming member with the base cover to hide them, bruise and cut of feet due to hitting the inclined surface setting member and/or the horizontal surface forming member are prevented and at the same time, beauty is added because structure member such as bolt is hid.

Further detailed explanation based on drawings of one embodiment of a leveling assembly for setting a vertical prop of the present invention is as follow.

### BRIEF EXPLANATION OF THE INVENTION

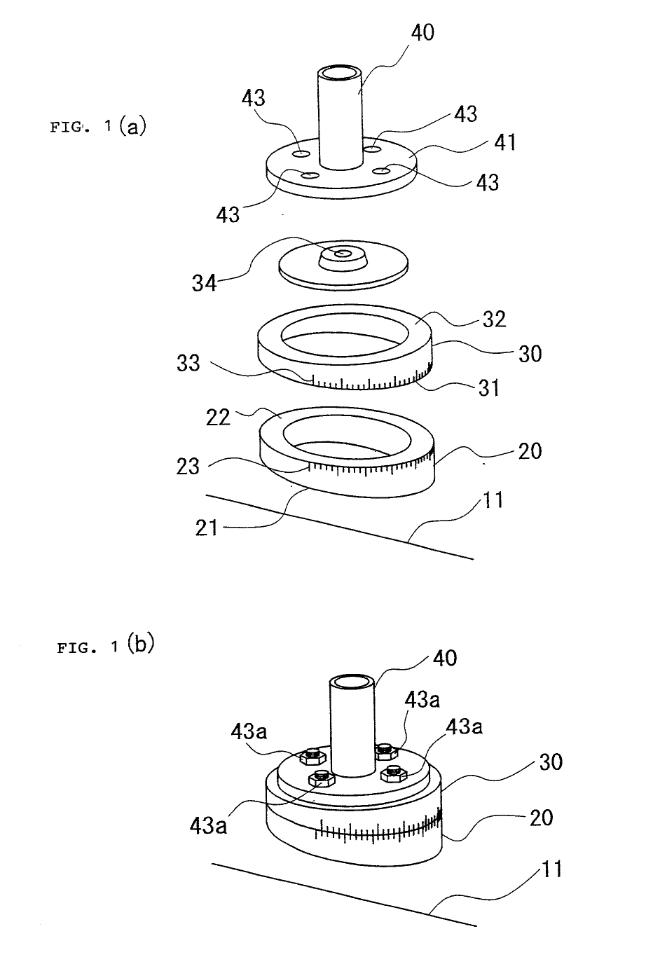

FIG. 1A is an exploded perspective view, and FIG. 1B is a perspective view of a first embodiment of a leveling assembly for setting a vertical prop according to the present invention.

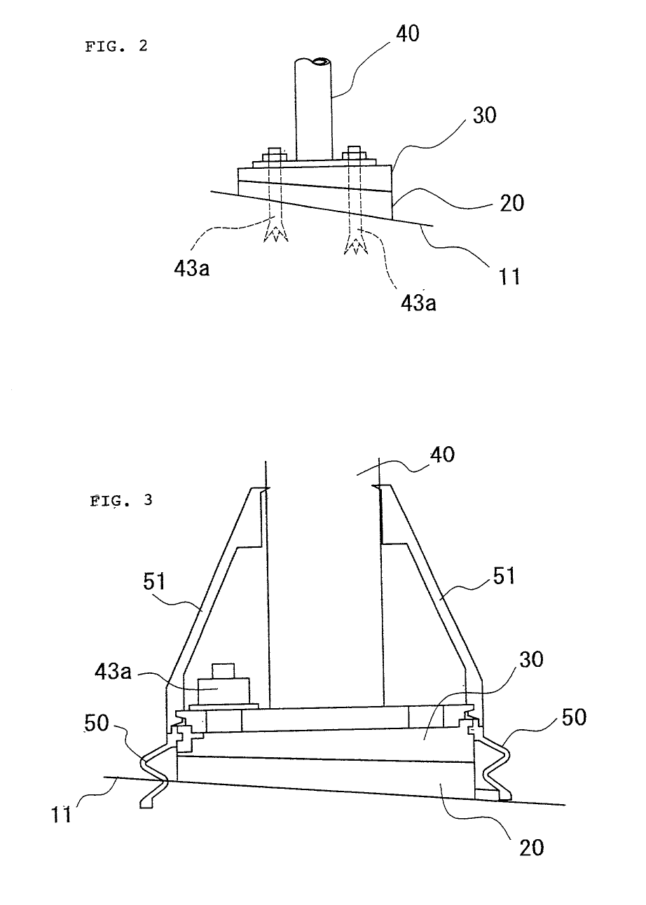

FIG. 2 is a side view of the embodiment shown in FIG. 1.

FIG. 3 is a cross sectional view showing a base cover.

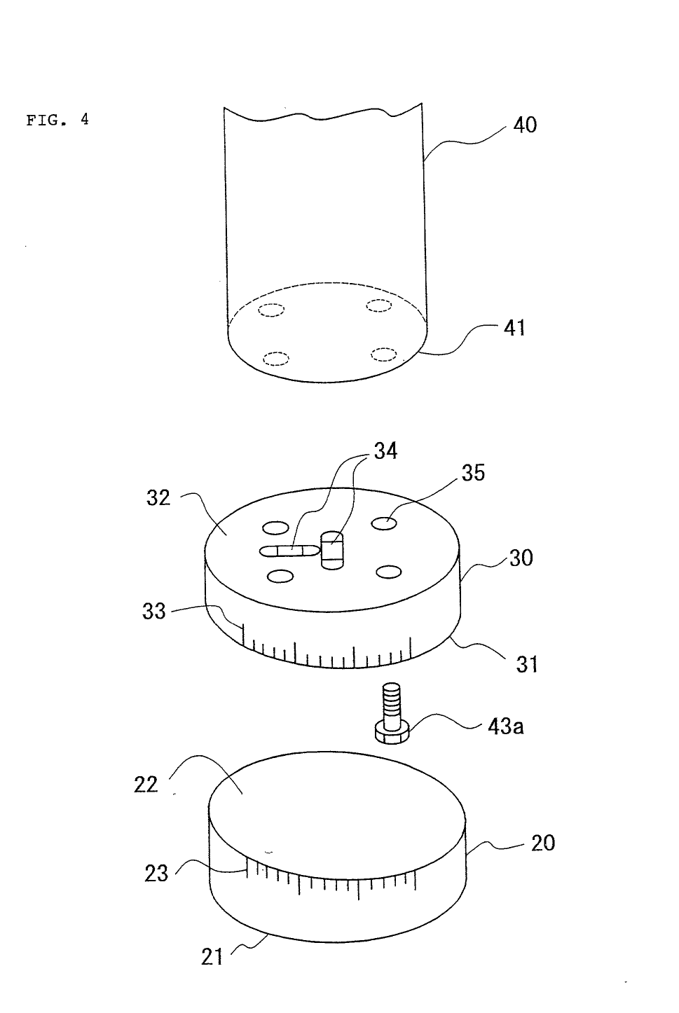

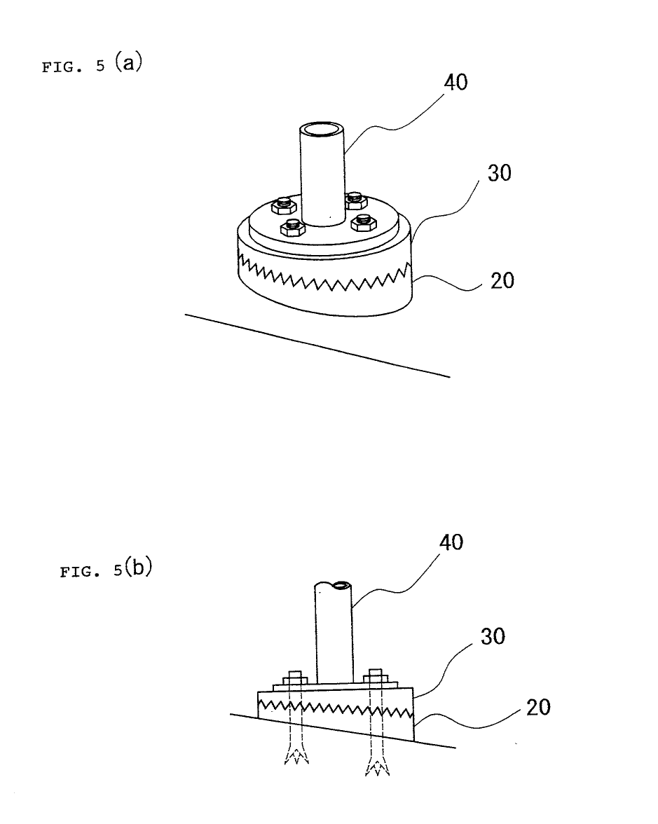

FIG. 4 is an exploded perspective view of a second embodiment of a leveling assembly according to the present invention.

FIG. 5A is an exploded perspective view, and FIG. 5B is side sectional view of a third embodiment of a leveling assembly according to the present invention.

### BEST MODE CARRING OUT THE INVENTION

FIG. 1A is an exploded perspective view, and FIG. 1B is an exploded perspective view of a first embodiment of a leveling assembly for setting a vertical prop according to the present invention.

The first embodiment of the present invention is a dais of slope for fixing a handrail pole 40 which comprises an inclined surface setting member 20 set on a slope inclined surface 11 and a horizontal surface forming member 30 supplied as a separate part from the inclined surface setting member 20. The inclined surface setting member 20 and the horizontal surface forming member 30 have structure comprised of two members formed by cutting a column member obliquity or at a degree not right angle to its lengthwise direction as shown in FIG. 1A.

As shown in FIG. 1A, an opposite surface to a horizontal surface 32 to which the slope fixing handrail pole 40 is placed on and is fixed is a first adjusting surface 31 not parallel to the horizontal surface 32. On the other hand, an opposite surface of a setting surface 21 facing the slope inclined surface 11 to which the inclined surface setting member 20 to be fixed is a second adjusting surface 22 facing the first adjusting surface 31. Further, in the horizontal surface forming member 30, a spirit level 34 is provided on the horizontal surface 32 for guiding and easily confirming horizontal state of the horizontal surface 32.

In this case, the second adjusting surface 22 and the first adjusting surface 31 are two surfaces formed by cutting a column member at a degree not right angle to its lengthwise direction, so rotating the first adjusting surface 31 to the second adjusting surface 22 is possible while they contact to each other closely. When the first adjusting surface 31 is rotated to the second adjusting surface 22, degree between the horizontal surface 32 and the setting surface 21 can be changed. And adjusting the horizontal surface 32 to be horizontal while watching the sprit level 34 makes possible to easily set the slope fixing handrail pole 40 vertically. When the horizontal surface 32 becomes horizontal, the horizontal surface forming member 30 is fixed to the inclined surface setting member 20. And the slope fixing handrail pole 40 is placed on the horizontal surface 32, and fixed by fixing members 43a such as bolts using holes 43 opened at a flange part 41. Alternatively, the horizontal surface forming member 30 may be temporarily fixed and adjusting by properly rotating the inclined surface setting member 20 to make the second adjusting surface 22 and the first adjusting surface 31 have an appropriate matching degree is also possible.

Next, graduation 23, 33 for grasping relative position of each other are formed on a peripheral surface of the inclined surface setting member 20 and on a peripheral surface of the horizontal surface forming member 30. Therefore, work of adjusting their relative position by rotating the first adjusting surface 31 to the second adjusting surface 22 and making the horizontal surface 32 horizontal is easily done.

Further, a base cover 50 is covered around the inclined surface setting member 20 and the horizontal surface forming member 30. In the present embodiment, the base cover 50 is formed from elastic member for example, rubber, synthetic resin, etc. and at the same time formed with bellows. And, a part of base cover 50 is fixed to a protecting cone member 51 covering a lower part of the slope fixing handrail pole 40 and the horizontal surface forming member 30.

With the dais for the slope fixing handrail pole 40 according to the present embodiment, in degree changing range of the horizontal surface 32 and the setting surface 21, supplying one kind is enough and burden of parts supplier may be lightened.

And, work of adjusting the horizontal surface 32 to be horizontal can be done by using the sprit level 34, and accordingly, burden of worker is lightened and keeping certain work quality without depending on worker's skill is possible.

FIG. 4 is an exploded perspective view of a second embodiment of a leveling assembly according to the present invention.

The second embodiment is almost the same as the first embodiment at the points that the inclined surface setting member 20 and the horizontal surface forming member 30 are structure comprised of two members formed by cutting a column member at a degree not right angle to its lengthwise direction, and having the sprit level 34 and the graduation 23, 33.

In more details, as shown in FIG. 3, the horizontal surface forming member 30 has the opposite surface to the horizontal surface 32 to be first adjusting surface 31 not parallel to the horizontal surface 32. And on the other hand, the opposite surface of the setting surface 21 facing the slope inclined surface 11 to be fixed of the inclined surface setting member 20 is to be the second adjusting surface 22 facing the first adjusting surface 31.

And the horizontal surface 32 is adjusted to be horizontal while watching the sprit level 34, and when the horizontal surface 32 becomes horizontal, the horizontal surface forming member 30 is fixed to the inclined surface setting member 20. And the slope fixing handrail pole 40 is fixed on the horizontal surface 32, by using the fixing members 43a through holes (not shown) formed in the horizontal surface forming member 30. Alternatively, the horizontal surface forming member 30 may be temporarily fixed and adjusting by properly rotating the inclined surface setting member 20 to make the second adjusting surface 22 and the first adjusting surface 31 have an appropriate matching degree is possible. Of course, the base cover 50 may be covered around the inclined surface setting member 20 and the horizontal forming member 30.

FIG. 5A is an exploded perspective view, and FIG. 5B is side sectional view of a third embodiment of a leveling assembly according to the present invention.

Third embodiment has mesh structure in the second adjusting surface 22 and the first adjusting surface 31 as shown in FIG. 4.

The mesh structure has two differences between the first embodiment as previously explained. The first difference or an advantage is work of holding temporarily the horizontal surface forming member 30 to the inclined surface setting member 20 becomes extremely easy. The second difference or disadvantage is smaller adjustment than mesh pitch becomes impossible. In case the mentioned disadvantage does not bring a big problem and the mentioned advantage can be used, structure of the present embodiment may be adopted.

Although the first and the second embodiments are explained as dais for the slope fixing handrail pole 40, it may be supplied properly as “zagane or metal washer” for building and house parts.

Moreover, in civil engineering, fixing the slope fixing handrail pole 40 is desired in some cases to a place where finish of slope is not done even though leveling of ground is finished. In such cases (not shown), providing burying portion into ground with the setting surface of the inclined surface setting member is preferable. Even if the burying portion may not be buried into the ground vertically, the slope fixing handrail pole 40 can be vertically fixed to horizontal surface forming member 30 by adjusting the first adjusting surface 31 to the second adjusting surface 22 while watching the sprit level 34.

In the present invention mentioned in Claims 1 to 3, supplying parts that are to lighten burden on parts supplier and at the same time lighten burden on worker and not to depend on worker's skill becomes possible.

Especially in the present invention mentioned in Claim 2 and 3, supplying parts that lightens burden on worker at adjusting work becomes possible.

In the present invention mentioned in Claim 4, supplying a leveling assembly for setting a vertical prop becomes possible that preventing bruise and cut of feet of the inclined surface setting member and/or the horizontal surface forming member becomes possible and at the same time, beauty is added because structure member such as bolt is hid.

What is claimed is:

1. A leveling assembly for setting a vertical prop comprised of an inclined surface setting member set on slope inclined surface and a horizontal surface forming member for fixing a vertical prop to be set vertically wherein;
said horizontal surface forming member having an upper horizontal surface set horizontal and a lower first adjusting surface formed by a surface not parallel to said horizontal surface,
said inclined surface setting member having a lower setting surface set on the slope inclined surface and an upper second adjusting surface formed by a surface not parallel to said setting surface, and,
said horizontal surface forming member and said inclined surface setting member to be piled to make said first adjusting surface and said second adjusting surface facing to each other, and, said horizontal surface to be always horizontal to the slope inclined surface by rotating relatively said piling position and changing degree between said horizontal surface and said setting surface.

2. A leveling assembly for setting a vertical prop mentioned in claim 1 being characterized in that;
said first adjusting surface and said second adjusting surface are formed by cutting a column member in obliquity into two members at their cutting surfaces, and,
graduation for grasping relative position of each other is set on peripheral surface of said inclined surface setting member and peripheral surface of said horizontal surface forming member.

3. A leveling assembly for setting a vertical prop mentioned in claim 1 or 2 being characterized in that a spirit level for confirming its horizontal position is provided on a surface of said horizontal surface forming member.

4. A leveling assembly for setting a vertical prop mentioned in any one of claims 1˜3 being characterized in that a base cover is provided around said inclined surface setting member and said horizontal surface forming member to hide them.
